(19) United States
(12) Patent Application Publication
(10) Pub. No.: US 2004/0135021 A1
(43) Pub. Date: Jul. 15, 2004

(54) Case

(75) Inventor: Yusuke Ishihara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/743,028

(22) Filed: Dec. 23, 2003

(30) Foreign Application Priority Data
Dec. 24, 2002 (JP) 2002-371592

(51) Int. Cl. G11B 23/107

(52) U.S. Cl. 242/348.2; 206/408

(57) ABSTRACT

In order to provide a case in which, when an upper case and a lower case are joined by fixing together by screws, joining accuracy of the upper case and the lower case can be improved, a case comprising an upper case and a lower case, the case being provided with screw bosses, disposed at predetermined positions at the upper case and the lower case, for joining the upper case and the lower case, wherein the screw bosses have socket and spigot joint structure in which a convex portion of one of the screw bosses and a concave portion of the other of the screw bosses are fitted, and an outer peripheral surface of the convex portion and an inner peripheral surface of the concave portion are inclined surfaces, are provided.

### CROSS-REFERENCE TO RELATED APPLICATION

This application claims priority under 35USC 119 from Japanese Patent Application No. 2002-371592, the disclosure of which is incorporated by reference herein.

### BACKGROUND OF THE INVENTION

1. Field of the Invention

The present invention relates to a case in which an upper case and a lower case are joined by fixing together by screws, for example, a case such as a recording tape cartridge or the like, accommodating, therein, a single reel on which is wound a recording tape, such as a magnetic tape or the like, which is used as a recording/playback medium of computers or the like.

2. Description of the Related Art

Conventionally, magnetic tape cartridges have been known in which a magnetic tape, which is used as a data recording/playback medium of a computer or the like, is wound on a single reel, and the reel is accommodated in a case. A leader member, such as a leader pin, a leader tape, or a leader block, is provided at the distal end of the magnetic tape. A pull-out means provided at a drive device pulls the leader member out from an opening of the magnetic tape cartridge, and winds the magnetic tape, which is fixed to the leader member, onto a take-up reel of the drive device.

A reel gear is formed in an annular form in the center of the bottom surface of a reel which emerges from an open hole formed in the bottom surface of the magnetic tape cartridge. Due to a driving gear, which is provided at a rotating shaft of the drive device, meshing with this reel gear, the reel is driven to rotate. By rotating the reel of the magnetic tape cartridge and the take-up reel of the drive device synchronously, data can be recorded onto the magnetic tape, and data recorded on the magnetic tape can be played back.

In the magnetic tape cartridge having the structure as mentioned above, a case made from synthetic resin, in which a single reel on which is wound a magnetic tape is accommodated, often has a structure in which an upper case and a lower case, each having substantially rectangle tray shape, are joined by a manner such as thermo welding, fixing together by screws or the like. Especially, in a case in which the upper case and the lower case are joined by fixing together by screws, screw bosses which face and abut each other are provided in a standing manner in a vicinity of corner portions of the upper case and the lower case. The screws are screwed into the screw bosses from the side of a lower surface (a bottom surface) of the lower case, thus, the upper case and the lower case are joined. (See Japanese Patent Application Laid-Open (JP-A) No. 11-339436.)

However, in a case of using such “fixing together by screws”, there may be a case in which abutting positions (positions of holes) of the upper case and the lower case slightly slip. If the screws are screwed in this state, there is fear in which distortion and the like occurs at the assembled case due to the slipping of the positions of the screw bosses. As a result, for example, there is fear in which the slidability of a door is lost in a case of a case such as a magnetic tape cartridge provided with the door which opens and closes an opening by slide movement.

### SUMMARY OF THE INVENTION

An object of the present invention is to provide a case in which, when an upper case and a lower case are joined by fixing together by screws, joining accuracy of screw bosses can be improved.

In order to achieve the above-described object, in a first aspect of the present invention, there is provided a case comprising an upper case and a lower case, the case being provided with screw bosses, disposed at predetermined positions at the upper case and the lower case, for joining the upper case and the lower case, wherein: the screw bosses have a socket and spigot joint structure in which a convex portion of one of the screw bosses and a concave portion of the other of the screw bosses are fitted together; and an outer peripheral surface of the convex portion and an inner peripheral surface of the concave portion are inclined surfaces.

In a second aspect of the present invention according to the first aspect, an inner peripheral surface of the convex portion is an inclined surface.

In a third aspect of the present invention according to the first aspect, an angle of the outer peripheral surface of the convex portion with respect to a vertical direction of the case is substantially equal to an angle of the inner peripheral surface of the concave portion with respect to the vertical direction.

In a fourth aspect of the present invention according to the third aspect, the angle of the outer peripheral surface and the angle of the inner peripheral surface are within a range between 30 degree and 60 degree.

In a fifth aspect of the present invention according to the first aspect, the convex portion is provided at the screw boss of the upper case and the concave portion is provided at the screw boss of the lower case.

In a sixth aspect of the present invention according to the first aspect, the convex portion is provided at the screw boss of the lower case and the concave portion is provided at the screw boss of the upper case.

In a seventh aspect of the present invention, there is provided a case comprising an upper case and a lower case, the case being provided with screw bosses, disposed at predetermined positions at the upper case and the lower case, for joining the upper case and the lower case, wherein: the screw bosses have a socket and spigot joint structure in which a convex portion of one of the screw bosses and a concave portion of the other of the screw bosses are fitted together; and the convex portion and the concave portion include guide portions for guiding fitting together of the convex portion and the concave portion respectively.

In an eighth aspect of the present invention according to the seventh aspect, the guide portion of the convex portion is an inclined outer peripheral surface of the convex portion, and the guide portion of the concave portion is an inclined inner peripheral surface of the concave portion.

In a ninth aspect of the present invention according to the eighth aspect, an angle of the outer peripheral surface of the convex portion with respect to a vertical direction of the case is substantially equal to an angle of the inner peripheral surface of the concave portion with respect to the vertical direction.

In a tenth aspect of the present invention according to the eighth aspect, an inner peripheral surface of the convex portion is an inclined surface.

In an eleventh aspect of the present invention, there is provided a case comprising an upper case and a lower case, the case being provided with screw bosses, disposed at predetermined positions at the upper case and the lower case, for joining the upper case and the lower case, wherein: the screw bosses have a socket and spigot joint structure in which a convex portion of one of the screw bosses and a concave portion of the other of the screw bosses are fitted together; an outer peripheral surface of the convex portion and an inner peripheral surface of the concave portion are inclined surfaces; and an angle of the outer peripheral surface of the convex portion with respect to a vertical direction of the case is substantially equal to an angle of the inner peripheral surface of the concave portion with respect to the vertical direction.

In the aspects of the present invention, the screw boss of the upper case and the screw boss of the lower case have the socket and spigot joint structure in which the screw boss of the upper case and the screw boss of the lower case are fitted in a convexoconcave manner. Therefore, even in a case in which there is forming error in the upper case and the lower case, each of the screws bosses can be assembled satisfactory. Further, the outer peripheral surface of the convex portion and the inner peripheral surface of the concave portion are the inclined surfaces. That is, the inclined surfaces play guide surfaces for guiding each other. Therefore, the screw bosses (the upper case and the lower case) can be assembled easily and joining accuracy can be improved.

Further, in the aspects of the present invention, because the inner peripheral surface of the convex portion is the inclined surface, as a result, a screw can be inserted (screwed) into the screw boss smoothly.

### BRIEF DESCRIPTION OF THE DRAWINGS

FIG. 1 is a schematic perspective view of a recording tape cartridge.

FIG. 2 is a schematic exploded perspective view of the recording tape cartridge.

FIG. 3 is a schematic perspective view of a lower case.

FIG. 4 is a schematic perspective view of an upper case.

FIG. 5 is a perspective enlarged view showing socket and spigot joint structure of a screw boss of the upper case and a screw boss of the lower case.

FIG. 6A is a cross sectional schematic view showing socket and spigot joint structure of the screw boss of the upper case and the screw boss of the lower case.

FIG. 6B is a cross sectional schematic view showing socket and spigot joint structure of the screw boss of the upper case and the screw boss of the lower case in joined state.

### DETAILED DESCRIPTION OF THE INVENTION

Hereinafter, a case relating to an embodiment of the present invention will be described on the basis of an example embodiment of a recording tape cartridge 10 shown in the drawings. First, the overall structure of the recording tape cartridge 10 will be briefly described, and then, main portions relating to the present invention will be described in detail. Note that, for convenience of explanation, the direction of loading the recording tape cartridge 10 into a drive device is denoted by arrow A, and this direction of arrow A is the forward direction (front side) of the recording tape cartridge 10. The direction of arrow B, which is orthogonal to the direction of arrow A, is the rightward direction.

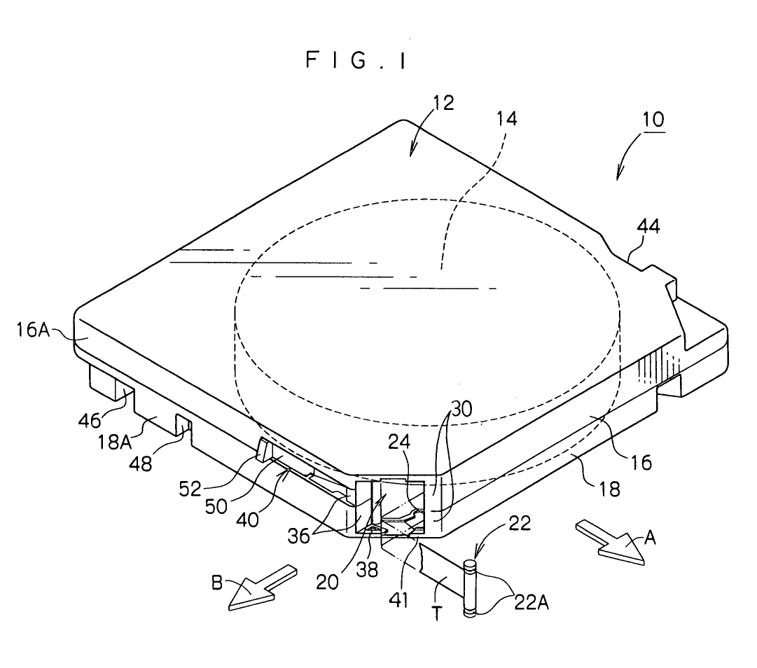

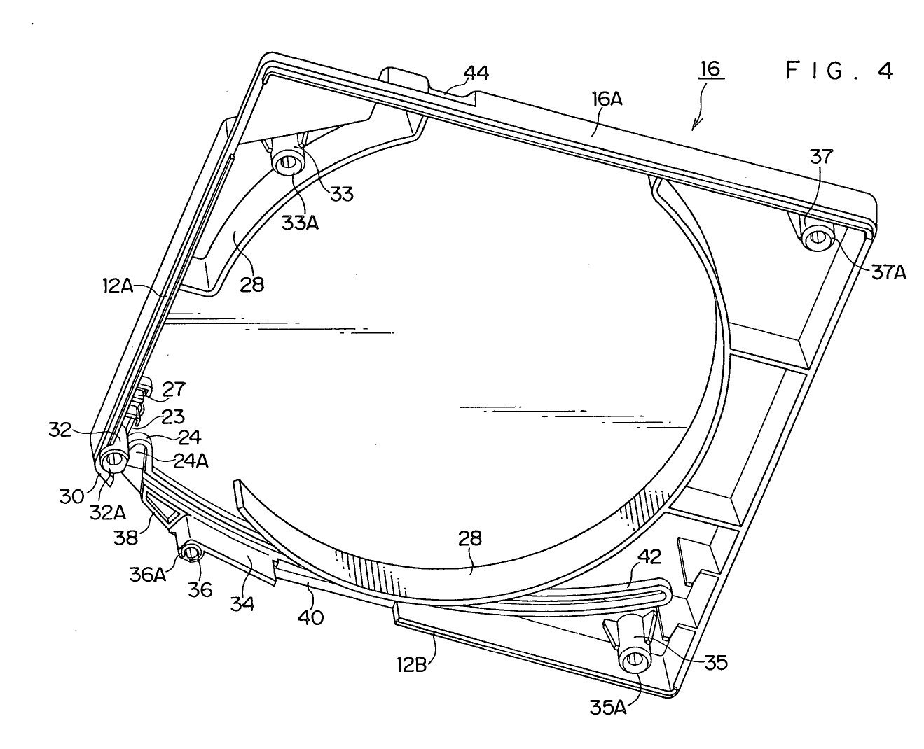

As shown in FIGS. 1 through 4, the recording tape cartridge 10 is structured such that a single reel 14, on which is wound a magnetic tape T serving as a recording tape which is an information recording/playback medium, is rotatably accommodated within a case 12 which is substantially rectangular as seen in plan view and made from synthetic resin. The case 12 is formed by joining together an upper case 16 and a lower case 18 with peripheral walls 16A, 18A thereof opposing each other. The front right corner portion of each of the upper case 16 and the lower case 18, which is one corner portion at the leading side in the direction of loading the recording tape cartridge 10 into a drive device, is cut off at an incline as seen in plan view. A space for accommodating the reel 14, on which the magnetic tape T is wound, is provided at the interior of the case 12.

Further, the corner portion of the upper case 16 and the lower case 18, at which corner portion the peripheral walls 16A, 18A have been cut off, forms an opening 20 which is for pulling-out of the magnetic tape T. A leader pin 22, which is pulled-out while being anchored (engaged) by a pull-out means (not shown in the drawings) of a drive device, is connected to the free end of the magnetic tape T which is pulled out from the opening 20. An annular groove 22A is formed in each of the end portions of the leader pin 22 which project out further than the transverse direction end portions of the magnetic tape T. The annular grooves 22A are anchored by hooks or the like of the pull-out means. In this way, the hooks or the like do not contact and scratch the magnetic tape T at the time of pulling-out the magnetic tape T.

A pair of upper and lower pin holding portions 24, which position and hold the leader pin 22 at the interior of the case 12, are provided at the inner side of the opening 20 of the case 12, i.e., at the inner surface of the ceiling plate of the upper case 16 and at the inner surface of the floor plate of the lower case 18. The pin holding portions 24 are formed in substantially semicylindrical shapes as seen in plan view, such that the magnetic tape T pull-out sides thereof are open. The end portions of the leader pin 22, which is in a state of standing upright, are held in concave portions 24A of the pin holding portions 24 so as to be able to enter therein and exit therefrom from the open sides thereof.

In vicinities of the pin holding portions 24, a proximal portion of a plate spring 25 is inserted and fixed in spring holding portions 27 and groove portions 23 which are provided at the inner surface of the front wall 12A. (The front wall 12A is the portions of the peripheral walls 16A, 18A where the outer surfaces face in the direction of arrow A.) The distal ends of the plate spring 25, which have been divided so as to be forked in two, engage with the upper and lower end portions of the leader pin 22 and hold the leader pin 22 in the pin holding portions 24. When the leader pin 22 enters into and exits from the pin holding portions 24, the distal end portions of the plate spring 25 elastically deform appropriately so as to permit movement of the leader pin 22.

Further, a gear opening 26, which is for exposing a reel gear (not shown the drawings) of the reel 14 to the exterior, is formed in the central portion of the lower case 18. The reel 14 is driven to rotate within the case 12 by the reel gear meshing with a driving gear of a drive device. Further, the reel 14 is held so as to not joggle by play restricting walls 28 which project out at portions of the inner surfaces of the upper case 16 and the lower case 18, and which serve as inner walls which are on a circular locus which is coaxial with the gear opening 26.

A bag portion 28A, in which a hole for position regulation is formed, is provided so as to be continuous with the end portion of the play restricting wall 28 in a vicinity of the opening 20. Further, a bag portion 29, in which is formed a hole for position regulation which is a long hole, is provided so as to be set apart from the play restricting wall 28 at the inner side of the front left corner portion of the case 12. The bag portions 28A, 29 are disposed on a single straight line which runs along the direction of arrow B. The end portions of the play restricting walls 28, except for the end portion thereof at which the bag portion 28A is continuous, are continuous with the peripheral wall 16A or the peripheral wall 18A of the case 12, so as to partition the outer sides of the play restricting walls 28 and the space at which the reel 14 is set.

Further, a pair of upper and lower screw bosses 33 are provided at predetermined positions between the play restricting wall 28 in a vicinity of the bag portion 29 and the front wall 12A at the lower case 18. Further, a pair of upper and lower screw bosses 35 are provided at predetermined positions in a vicinity of the right wall 12B and at the right side of the rear portion inner wall 18B (in a vicinity of one of the corner portions at the rear portion inner wall 18B). Moreover, a pair of upper and lower screw bosses 37 are provided at predetermined positions in a vicinity of the left wall 12C and at the left side of the rear portion inner wall 18B (in a vicinity of the other of the corner portion at the rear portion inner wall 18B). These pairs of upper and lower screw bosses 33, 35 and 37 penetrate the lower case 18 side but do not penetrate the upper case 16 side. The screws (not shown in the drawings) are screwed from the lower surface (the bottom surface) side of the lower case 18.

A memory board M, which stores various types of information, is set at the rear right portion of the lower case 18 for each recording tape cartridge 10. A rear portion inner wall 18B, except for the both end portions of the lower case 18, is formed at an inclined surface of a predetermined angle and the memory board M is supported by the rear portion inner wall 18B and the supporting projections 19 so as to be inclined at a predetermined angle, such that sensing is possible at a drive device which reads from the lower surface side (the bottom surface side) of the case 12 and at a library device (a device which accommodates a plurality of the recording tape cartridges 10 and which automatically loads and removes the recording tape cartridges 10 into and from drive devices) which reads from the rear wall side (the back surface side).

A write protect portion (not shown in the drawings), which is set so that recording onto the recording tape cartridge 10 is possible or is not possible, is provided at the left rear portion of the lower case 18 so as to be slidable in the right and left (widthwise) direction. At the rear portion inner wall 18B, an open hole 15, through which projects an operating projection for operation of the write protect portion by an operator's hand, is formed in a drill manner. The open hole 15 has substantially rectangle shape. An open hole 17, from which exposes an identification projection for identifying whether or not the drive device can record, is formed in a drill manner. The open hole 17 has substantially ellipse shape.

Further, a pair of top and bottom inclined wall portions 30, which are short and which prescribe the front edge portion of the opening 20, are provided at the right end portion of a front wall 12A of the case 12. The inclined wall portions 30 are bent along the plane of opening of the opening 20. The inclined wall portions 30 serve as dustproofing walls such that no gap through which dust or the like can enter arises, due to the distal end of a door 50, which is substantially arc-shaped in plan view and which will be described later, entering in at the inner side of the inclined wall portions 30 when the opening 20 is closed. Further, a pair of upper and lower screw bosses 32 are provided continuously with the inner side of the front wall 12A in vicinities of the left sides of the inclined wall portions 30.

On the other hand, a pair of upper and lower inclined wall portions 34, which are shaped, in plan view, so as to substantially follow along the outer peripheral surface of the door 50, are provided at the inner side of the front end portion of a right wall 12B of the case 12. (The right wall 12B is the portions of the peripheral walls 16A, 18A where the outer surfaces thereof face in the direction of arrow B.) The front end surfaces of the inclined wall portions 34 prescribe the rear edge of the opening 20. A pair of upper and lower screw bosses 36 are provided at the front end portions of the inclined wall portions 34.

Further, a slit 40, which is of a predetermined length and serves as a window portion which communicates the interior and the exterior of the case 12, is formed in the right wall 12B of the case 12. The slit 40 is for exposing an operation projection 52 of the door 50 which will be described later. The slit 40 is formed by cutting-out the lower portion of the front side of the peripheral wall 16A of the upper case 16 which forms the right wall 12B in a substantially rectangle shape, and the slit 40 opens toward the opening 20 as well. Forming the slit 40 in this way such that a portion of the peripheral wall 16A remains at the upper side is preferable in that the rigidity of the case 12 can be maintained. In particular, it is more preferable that the upper side wall prescribing the slit 40 be integral and continuous with the inclined wall portion 34.

A concave portion 48 is formed at the rear side of the lower case 18. The portion of the concave portion 48, other than the upper end of the peripheral wall 18A, is recessed toward the inner side of the case 12 in a substantially U-shaped configuration as seen in cross-sectional view, and is recessed upwardly from the bottom surface of the case 12 as well (the floor plate is cut-out). The concave portion 48 is formed at the left wall 12C side of the case 12 as well. The concave portions 48 are engagement portions which, for example, a pull-in means (not shown in the drawings) of a drive device engages. The floor surfaces (the downwardly-facing surfaces) of the concave portions 48 serve as reference surfaces for positioning within a drive device.

Concave portions 46 are formed at the rear sides of the concave portions 48. The portion of the concave portion 46, other than the upper end of the peripheral wall 18A, is recessed toward the inner side of the case 12 in a substantially U-shaped configuration as seen in cross-sectional view, and is recessed upwardly from the bottom surface of the case 12 as well (the floor plate is cut-out). The concave portions 46 are engagement portions which a grasping means of a library device engages. By providing the concave portions 46, 48, the torsional strength of the case 12 (the lower case 18) is improved.

Moreover, a concave portion 44, which is substantially trapezoidal as seen in plan view, is formed in the top surface portion of the left wall 12C of the upper case 16. This concave portion 44 is an engagement portion which is engaged by a holding member (not shown in the drawings) for canceling the rotational moment accompanying the movement of the door 50 in the direction of opening at the time of opening the opening 20.

Guide wall portions 42, which are predetermined heights (e.g., about 1.0 mm to 1.5 mm) and which support convex portions 51 of the door 50 (which will be described later) such that the convex portions 51 are nipped from both the inner surface side and the outer surface side, stand erect at the upper case 16 and the lower case 18 from a vicinity of the opening 20 to a vicinity of the region where the play restricting walls 28 are closest to the right wall 12B (hereinafter, these portions will be called the front half guide wall portions 42), and from a vicinity of the rear end of the slit 40 to a vicinity of the rear wall (hereinafter, these portions will be called the rear half guide wall portions 42).

The guide wall portions 42 are formed in substantial arc-shapes as seen in plan view, and have different lengths at the upper case 16 and the lower case 18. The guide wall portion 42 at the upper case 16 is formed such that the rear half side thereof is longer than that of the guide wall portion 42 at the lower case 18. This is because the memory board M is disposed so as to be inclined at a predetermined angle at the right wall 12B side of the rear portion inner wall 18B of the lower case 18.

Further, the rear end portions of the guide wall portions 42 are closed in substantial arc-shapes as seen in plan view, and restrict the convex portions 51 which are furthest toward the rear at both the top and bottom of the door 50 such that the door 50 cannot move any further rearward. The front end portions of the guide wall portions 42 opens and extend to positions which, when the leader pin 22 is entering and exiting, do not impede the entry or exit of the leader pin 22 (in the illustrated structure, positions which are about half of the opening width of the opening 20 and which are further rearward than pin holding portions 24 which will be described later).

Guide wall portions 41, whose rear end portions are open, stand erect in vicinities of the inclined wall portions 30 so as to be positioned on imaginary lines extending from the guide wall portions 42. The rear end portions of the guide wall portions 41 do not extend further rearward than the front ends of the pin holding portions 24, so as to not impede the entry and exit of the leader pin 22. The interval (groove width) of the guide wall portion 41 is formed so as to be slightly more narrow than the interval (groove width) of the guide wall portion 42.

Namely, the interval (groove width) of the guide wall portion 42 is slightly wider so as to permit dispersion in molding of the door 50 (dispersion in the curvature). The convex portions 51 of the door 50 slide within the guide wall portions 42 in a state in which there is a certain amount of joggling. Accordingly, the interval (groove width) of at least the guide wall portion 41 is substantially the same size as the width of the convex portion 51 of the door 50. Due to the front most convex portions 51 being fit into the guide wall portions 41 when the opening 20 is closed, the door 50 can be held without joggling.

The guide wall portions 41 and the front half guide wall portions 42 are formed so as to be slightly lower than the rear half guide wall portions 42. Namely, for example, the heights of the guide wall portions 41 and the front half guide wall portions 42 are formed to be about 1 mm, whereas the heights of the rear half guide wall portions 42 are formed to be about 1.5 mm. This is in order to ensure, at the opening 20, space for entry of the pull-out means of a drive device which engages and pulls-out the leader pin 22. Accordingly, as will be described later, the plate width (height) of the front half portion of the door 50 (at least the portion thereof which closes the opening 20) is formed to be larger (higher) by an amount corresponding to the amount by which the guide wall portions 41 and the front half guide wall portions 42 are made lower.

Further, ribs 38, which are substantially trapezoidal in plan view and which are integral with the guide wall portions 42 at the outer sides which are exposed from the opening 20, stand erect at the inner surface of the upper case 16 and the inner surface of the lower case 18 so as to be the same heights as these guide wall portions 42. The strength of the upper case 16 and the lower case 18 at the opening 20 portion is ensured by these ribs 38. The guide wall portion 42 at the inside and the pin holding portion 24 are provided in a connected arrangement so as to be integrated with each other. It is preferable that the height of the pin holding portion 24 is substantially equal to or higher than that of the guide wall portion 42 which is provided in a connected arrangement so as to be integral with the pin holding portion 24.

The upper case 16 and the lower case 18 which have been described above are fixed (joined) together by screws being screwed, from the side of the lower surface (the bottom surface) of the lower case 18, into each of screw bosses 32, 36 which are positioned in the vicinities of the edge portions of the opening 20, and each of the screw bosses 33, 35 and 37 described above. In this way, especially, the corner portions at both ends of the opening 20, which are prescribed by the free ends of the inclined wall portions 30 (the front wall 12A) and the inclined wall portions 34 (the right wall 12B) and which are disadvantageous in terms of strength and which easily hit the ground or the like when the case 12 is dropped, are joined together strongly. Even if the case 12 is dropped, it is difficult for the case 12 to deform or buckle, or for positional offset to arise thereat, due to the entire weight of the recording tape cartridge 10. Fixing together by screws is preferable in consideration of the ability to disassemble and the ability to recycle the case 12.

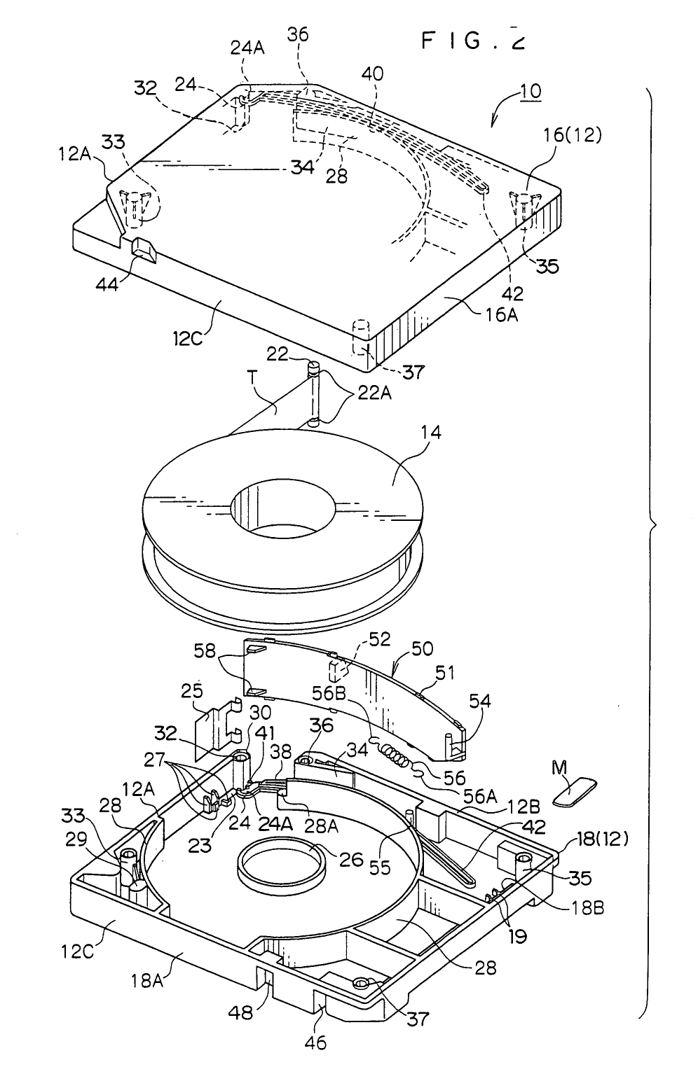

The opening 20 is opened and closed by the door 50 which serves as a shielding member. The plate width (height) of the portion of the door 50 which slides in the guide wall portions 41 and the front half guide wall portions 42 (i.e., at least the portion of the door 50 which closes the opening 20) is formed to be substantially the same as the opening height of the opening 20. The portion at the rear side thereof is formed to be slightly smaller (lower). The plate length of the door 50 is formed to be sufficiently larger than the opening width of the opening 20. The door 50 is formed in a substantial arc-shape as seen in plan view which curves along the direction of plate thickness, such that the door 50 can move along a predetermined circumference. (See FIG. 2)

The door 50 closes the opening 20 in a state in which the distal end portion of the door 50 enters in at the inner sides of the inclined wall portions 30. When the door 50 slides (rotates) substantially rearward along the aforementioned predetermined circumference so as to open the opening 20 and the outer peripheral surface of a vicinity of the distal end of door 50 reaches a vicinity of the screw bosses 36, the opening 20 is completely opened. Further, the door 50 closes the opening 20 by sliding (rotating) in the direction opposite to the direction at the time of opening the opening 20.

The door 50 is formed to be curved in an arc-shape which corresponds to a predetermined circumference which is the locus of movement of the door 50. In the present embodiment, the center of rotation of the door 50 is set such that the left-right direction position thereof is in a vicinity of the left end of the case 12 and the front-back direction position thereof is in a vicinity of the rear end of the slit 40. In this way, the locus of movement of the door 50 comes closest to the right wall 12B of the case 12 in a vicinity of the rear end of the slit 40. Note that the center of rotation and the radius of the door 50 may be appropriately determined in accordance with the positions of the front and rear edge portions of the opening 20 (the inclined wall portions 30 and the screw bosses 36) which are determined in accordance with requirements of drive devices, or the angle of the plane of opening of the opening 20 which is determined in accordance with requirements of library devices, or the like.

The curved longitudinal dimension of the door 50 is determined such that, in the state in which the door 50 closes the opening 20, the rear end portion of the door 50 is positioned in the right rear corner portion of the case 12, which is further toward the rear than the concave portion 48 (i.e., the right rear corner portion in a vicinity of the concave portion 46). The bottom rear portion of the door 50 is cut at an incline in order to avoid the memory board M which is disposed so as to be inclined at a predetermined angle at the rear portion inner wall 18B of the lower case 18. The inner surface and/or the outer surface at the distal end portion (front end portion) of the door 50 is preferably formed as a tapered surface so as to smoothly enter into the guide wall portions 41.

The convex portions 51 project from the top surface and the bottom surface of the door 50. The convex portions 51 abut the guide surfaces of the guide wall portions 41 and the guide wall portions 42 (the inner surfaces which oppose each other) and the inner surface of the upper case 16 and the inner surface of the lower case 18 between the guide wall portions 41 and the guide wall portions 42, and guide the door 50 in the directions of opening and closing the opening 20. The convex portions 51 are formed in substantially oval shapes as seen in plan view which are long along the longitudinal direction of the door 50. Four convex portions 51 project at each of the top surface and the bottom surface of the door 50 so as to have top/bottom symmetry (except for the convex portions 51 furthest toward the rear), and so as to project to substantially the same heights as the heights of the guide wall portions 41 and the guide wall portions 42 (for example, about 0.5 mm at the front side of a border portion where the plate width of the door 50 changes, and about 1.5 mm at the rear side of this border portion). Note that the convex portions 51 furthest toward the rear do not have top/bottom symmetry because the bottom rear portion of the door 50 is cut obliquely.

Thus, by providing such convex portions 51, the sliding resistance (friction) between the door 50 and the inner surface of the upper case 16 and the inner surface of the lower case 18 between the guide wall portions 41 and the guide wall portions 42, and the sliding resistance (friction) between the door 50 and the guide surfaces of the guide wall portions 41 and the guide wall portions 42, can be reduced, and the door 50 can be slid smoothly with little resistance. Note that, when the convex portions 51 are formed in substantially oval shapes as seen in plan view, the impact resistance thereof is better than if, for example, the convex portions 51 were to be formed in substantially circular shapes as seen in plan view. Thus, even if force is applied to the door 50 from a direction other than the opening/closing directions due to the impact of a drop or the like, there is no fear of breaking.

An operation projection 52 serving as an operation portion projects along the radial direction of the door 50 from the outer peripheral surface of the door 50 at a region which is slightly further forward than the longitudinal direction central portion of the door 50 (i.e., at a vicinity of the border portion where the plate width of the door 50 changes). The operation projection 52 is exposed to the exterior of the case 12 from the slit 40. In the state in which the opening 20 is closed, the operation projection 52 is positioned so as to be slightly set apart from the rear end of the screw boss 36, and can be operated from the portion of the slit 40 which opens toward the front. Further, in the state in which the opening 20 is open, the operation projection 52 is positioned so as to be slightly set apart from the rear edge of the slit 40. At this time, the rear most convex portions 51 abut the rear end portions of the guide wall portions 42.

Further, stoppers 58, which abut the upper end portion side surface and the lower end portion side surface of the leader pin 22 when the opening 20 is closed, project at the inner surface of the front end portion of the door 50. The stoppers 58 can even further prevent the leader pin 22 from falling out from the pin holding portions 24 due to impact of a drop or the like. Further, a coil spring 56, which serves as an urging member which urges the door 50 in the direction of closing the opening 20, has a length such that it extends to the rear right corner portion of the case 12 in the state in which the door 50 closes the opening 20. Thus, the space between the play restricting walls 28 and the right wall 12B (the peripheral walls 16A, 18A) at the rear right corner portion can be utilized effectively.

Namely, a spring holding portion 54, which is substantially L-shaped in rear view, projects integrally at the inner peripheral surface of the door 50 in the vicinity of the rear end thereof, so as to be directed upwardly. A solid cylindrical spring anchor portion 55 projects upwardly at the inner surface of the lower case 18 in a vicinity of the concave portion 48. Ring-shaped attachment portions 56A, 56B are formed at the both ends of the coil spring 56. Accordingly, the one attachment portion 56B of the coil spring 56 is placed on the spring anchor portion 55 from above such that the spring anchor portion 55 is inserted through the attachment portion 56B, and the other attachment portion 56A is placed on the spring holding portion 54 from above such that the spring holding portion 54 is inserted through the attachment portion 56A. The coil spring 56 can thereby be attached simply within the aforementioned space.

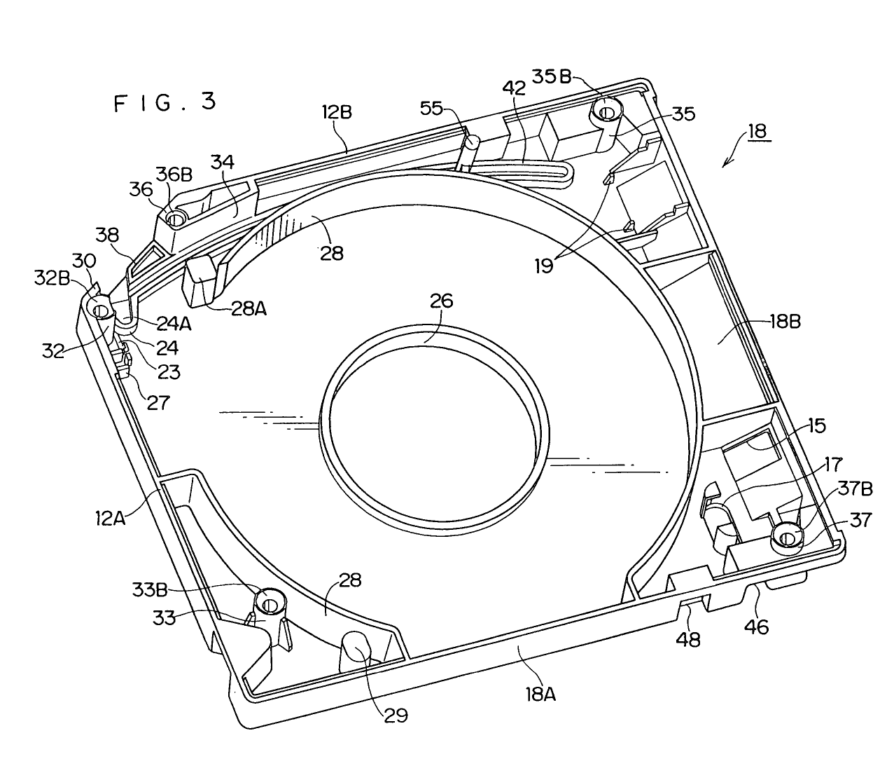

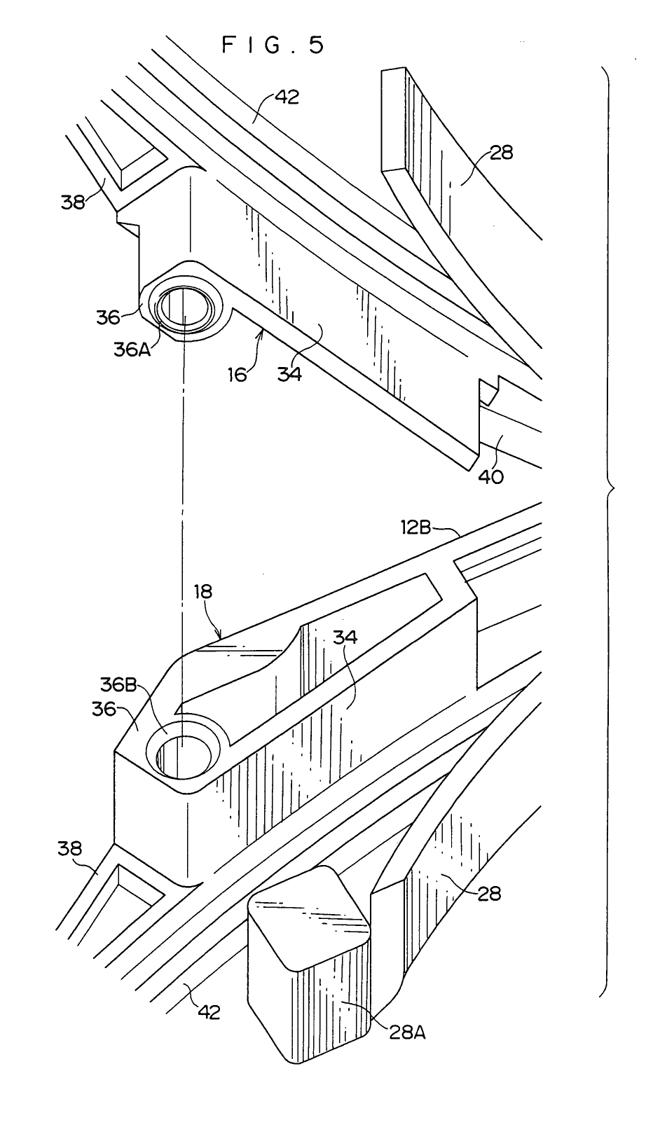

In the recording tape cartridge 10 having the structure as mentioned above, the case 12 is joined by fixing together by screws as mentioned above. As shown in FIGS. 3, 4, 5, 6A and 6B, cylinder shaped convex portions 32A, 33A, 35A, 36A and 37A are respectively formed at tip end portions (lower end portions) of the screw bosses 32, 33, 35, 36 and 37 of the upper case 16. Further, ring shaped concave portions 32B, 33B, 35B, 36B and 37B are respectively formed at tip end portions (upper end portions) of the screw bosses 32, 33, 35, 36 and 37 of the lower case 18. Each of the screw bosses 32, 33, 35, 36 and 37 have socket and spigot joint structure in which the tip end portions (that is, the upper end portion and the lower end portion) of each of the screw bosses 32, 33, 35, 36 and 37 are abutted each other and fitted together (fitted in a concave-convex manner).

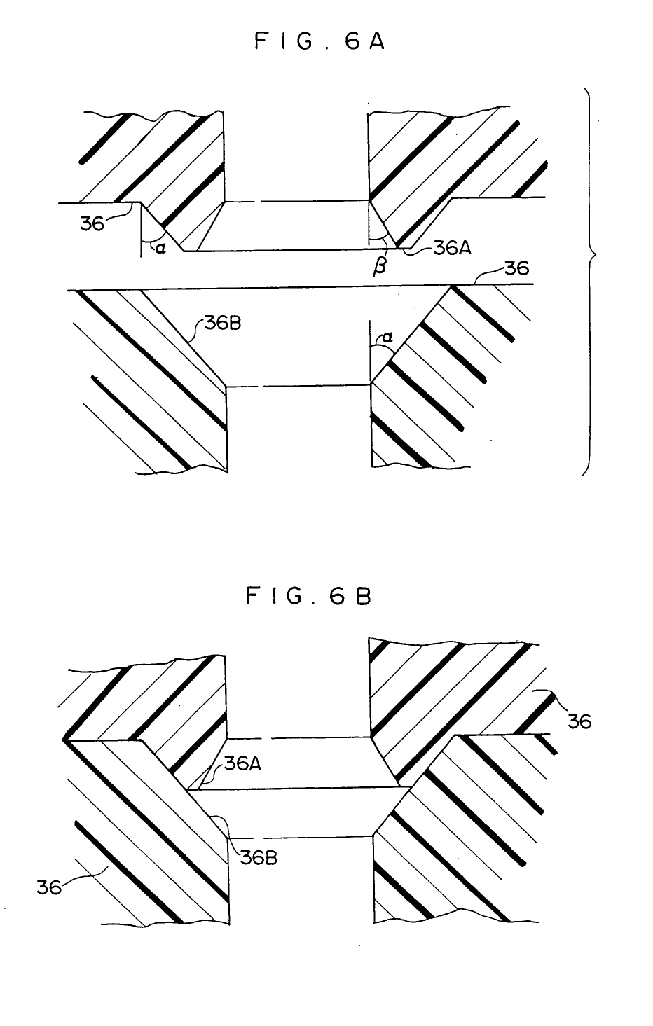

Further, tip end inner peripheral surfaces and tip end outer peripheral surfaces of the cylinder shaped convex portions 32A, 33A, 35A, 36A and 37A are formed as inclined surfaces (hereinafter, taper surfaces) which are substantially V-shaped configuration as seen in cross-sectional view, as shown in FIGS. 6A and 6B. Also, end portion inner peripheral surfaces of the ring shaped concave portions 32B, 33B, 35B, 36B and 37B are formed as inclined surfaces (hereinafter, taper surfaces) which are correspond to (abutted on) the respective tip end outer peripheral surfaces of the cylinder shaped convex portions 32A, 33A, 35A, 36A and 37A. Accordingly, when the upper case 16 and the lower case 18 are assembled, the taper surfaces of the cylinder shaped convex portions 32A, 33A, 35A, 36A and 37A and the taper surface of the ring shaped concave portions 32B, 33B, 35B, 36B and 37B serve as guide surfaces for guiding each other. Therefore, even in a case in which there is forming (molding) error in the upper case 16 and the lower case 18, each of the screws bosses 32, 33, 35, 36 and 37 can be assembled (abutted and fitted) smoothly.

Further, when the screws are inserted from the side of the lower surface (the bottom surface) of the lower case 18 and screwed, because the tip end inner peripheral surfaces of the cylinder shaped convex portions 32A, 33A, 35A, 36A and 37A of the screws bosses 32, 33, 35, 36 and 37 of the upper case 16 serve as guide surfaces for guiding tip ends of the screws. Therefore, the screws also can be inserted (screwed) into the screws bosses 32, 33, 35, 36 and 37 of the upper case 16 smoothly.

As described above, the taper surfaces are provided at the cylinder shaped convex portions 32A, 33A, 35A, 36A and 37A and the ring shaped concave portions 32B, 33B, 35B, 36B and 37B which forming the socket and spigot joint structure. As a result, the screws bosses 32, 33, 35, 36 and 37 can be assembled easily and satisfactory while positional shifts (slips) and the like of the screws bosses 32, 33, 35, 36 and 37 are regulated. Therefore, joining accuracy of the upper case 16 and the lower case 18 can be improved. Accordingly, distortion and the like of the case 12 does not occur, and the door 50 can be slid smoothly.

The socket and spigot joint structure in which the cylinder shaped convex portions 32A, 33A, 35A, 36A and 37A are provided at the respective screw bosses 32, 33, 35, 36 and 37 of the lower case 18 and the ring shaped concave portions 32B, 33B, 35B, 36B and 37B are provided at the respective screw bosses 32, 33, 35, 36 and 37 of the upper case 16 is also possible. In this case, the cylinder shaped convex portion 36A in FIGS. 6A and 6B is provided at the screw boss 36 of the lower case 18 and the ring shaped concave portion 36B in FIGS. 6A and 6B is provided at the screw boss 36 of the upper case 16. That is, the socket and spigot joint structure is not limited to the structure shown in the drawings. Further, in the embodiment, all of the cylinder shaped convex portions 32A, 33A, 35A, 36A and 37A are provided at the respective screw bosses 32, 33, 35, 36 and 37 of the upper case 16 and all of the ring shaped concave portions 32B, 33B, 35B, 36B and 37B are provided at the respective screw bosses 32, 33, 35, 36 and 37 of the lower case 18. However, the present invention is not limited to the same. The socket and spigot joint structure in which at least one (some) of the cylinder shaped convex portions 32A, 33A, 35A, 36A and 37A is provided at the screw boss of the lower case 18 and corresponding at least one (some) of the ring shaped concave portions 32B, 33B, 35B, 36B and 37B is provided at the screw boss of the upper case 16 is also possible. It is preferable that inclined angles α and β (see FIG. 6A), which are angles of the taper surfaces with respect to the vertical direction, are within the range between 30 degree and the 60 degree, and about 45 degree is optimum angle.

Next, operation of the present embodiment will be described. When the recording tape cartridge 10 provided with the case 12 having the above-described structure is not being used (i.e., is being stored, is being transported, or the like), the opening 20 is closed by the door 50. Specifically, due to the urging force of the coil spring 56, the door 50 is always urged in the direction of closing the opening 20, and closes the opening 20 in a state in which the distal end portion (front end portion) of the door 50 has entered inside the guide wall portions 41 and the inclined wall portions 30.

On the other hand, when the magnetic tape T is to be used, the recording tape cartridge 10 is loaded into a drive device along the direction of arrow A. Accompanying this loading, an opening/closing member (not illustrated) forming an opening/closing means of the drive device enters into the slit 40 which opens toward the front, and engages with the operation projection 52 of the door 50. In this state, when the recording tape cartridge 10 (the case 12) is pushed in further, due to the pushing-in force, the opening/closing member moves the operation projection 52 rearward against the urging force of the coil spring 56 (i.e., moves the operation projection 52 rearward relative to the case 12 which is loaded in the direction of arrow A). The opening/closing member extends in a direction traversing the direction of insertion of the cartridge.

Then, while the convex portions 51 are guided by the guide wall portions 42 and the spring holding portion 54 is guided by the rib 57, the door 50, from which the operation projection 52 projects, rotates clockwise as seen in plan view along the direction of curving thereof. Namely, due to the guide wall portions 42, the door 50 moves substantially rearward so as to circle around the outer sides of the pin holding portions 24 and the reel 14 without jutting out from the locus of movement along the curved configuration of the door 50, and opens the opening 20. Then, when the case 12 (the recording tape cartridge 10) is loaded to a predetermined depth in the drive device, the opening 20 is completely opened.

When the recording tape cartridge 10 is positioned within the drive device in this state in which the opening 20 is opened, further rotation (substantially rearward movement) of the door 50 is restricted. The pull-out means of the drive device enters into the case 12 from the opening 20 which has been opened. The pull-out means pulls-out the leader pin 22 which is positioned and held at the pin holding portions 24. At this time, the distal ends of the anchor spring 25 elastically deform appropriately, such that pulling-out of the leader pin 22 from the pin holding portions 24 is permitted. Then, the leader pin 22 is accommodated at a take-up reel (not shown in the drawings), and the take-up reel and the reel 14 are driven to rotate synchronously. Thus, the magnetic tape T is successively pulled-out from the case 12 while being taken-up onto the take-up reel. Information is recorded or played back by a recording/playback head or the like disposed along a predetermined tape path.

On the other hand, when the recording tape cartridge 10 is ejected from the drive device, the magnetic tape T is rewound onto the reel 14 and the leader pin 22 is to be held at the pin holding portions 24. Then, the positioned state of the recording tape cartridge 10 is cancelled, and the recording tape cartridge 10 is moved in the direction opposite to the direction of arrow A by the urging force of the coil spring 56 or by an unillustrated ejecting mechanism. In this way, the door 50 is rotated in the direction of closing the opening 20 by the urging force of the coil spring 56, while the convex portions 51 are guided by the guide wall portions 42. Due to the distal end portion (front end portion) of the door 50 entering into the guide wall portions 41, the opening 20 is completely closed and returned to its initial state.

Here, because each of the screw bosses 32, 33, 35, 36 and 37 provided at the upper case 16 and the lower case 18 are formed to have the socket and spigot joint structure in which each of the screw bosses 32 (33, 35, 36, 37) is fitted together in the concave-convex manner. Further, the outer peripheral surfaces of the cylinder shaped convex portions 32A, 33A, 35A, 36A and 37A provided at ones of the screw bosses 32, 33, 35, 36 and 37 (provided at the screw bosses 32, 33, 35, 36 and 37 at the upper case 16), and the inner peripheral surfaces of the ring shaped concave portions 32B, 33B, 35B, 36B and 37B provided at the others of the screw bosses 32, 33, 35, 36 and 37 (provided at the screw bosses 32, 33, 35, 36 and 37 at the lower case 18) are formed as the guide surfaces which guide corresponding others. As a result, the case 12 can be assembled (abutted and fitted) easily and satisfactory while positional shifts and the like of the screws bosses 32, 33, 35, 36 and 37 are regulated.

Further, because the inner peripheral surfaces of the cylinder shaped convex portions 32A, 33A, 35A, 36A and 37A are formed as the taper surfaces, the screws also can be inserted (screwed) into the screws bosses 32, 33, 35, 36 and 37 smoothly. As a result, the upper case 16 and the lower case 18 can be joined with high accuracy. Accordingly, distortion and the like of the case 12 does not occur, and trouble in which the slidability of the door 50 is lost does not occur in a case in which the case is provided with the door 50.

In the present invention, even in a case in which there is forming error in the upper case and the lower case, each of the screws bosses can be assembled easily and satisfactory. Therefore, joining accuracy of the upper case and the lower case can be improved.

What is claimed is:

1. A case comprising an upper case and a lower case, the case being provided with screw bosses, disposed at predetermined positions at the upper case and the lower case, for joining the upper case and the lower case, wherein:
the screw bosses have a socket and spigot joint structure in which a convex portion of one of the screw bosses and a concave portion of the other of the screw bosses are fitted together; and
an outer peripheral surface of the convex portion and an inner peripheral surface of the concave portion are inclined surfaces.

2. A case according to claim 1, wherein an inner peripheral surface of the convex portion is an inclined surface.

3. A case according to claim 1, wherein an angle of the outer peripheral surface of the convex portion with respect to a vertical direction of the case is substantially equal to an angle of the inner peripheral surface of the concave portion with respect to the vertical direction.

4. A case according to claim 3, wherein the angle of the outer peripheral surface and the angle of the inner peripheral surface are within a range between 30 degree and 60 degree.

5. A case according to claim 1, wherein the convex portion is provided at the screw boss of the upper case and the concave portion is provided at the screw boss of the lower case.

6. A case according to claim 1, wherein the convex portion is provided at the screw boss of the lower case and the concave portion is provided at the screw boss of the upper case.

7. A case comprising an upper case and a lower case, the case being provided with screw bosses, disposed at predetermined positions at the upper case and the lower case, for joining the upper case and the lower case, wherein:
the screw bosses have a socket and spigot joint structure in which a convex portion of one of the screw bosses and a concave portion of the other of the screw bosses are fitted together; and
the convex portion and the concave portion include guide portions for guiding fitting together of the convex portion and the concave portion respectively.

8. A case according to claim 7, wherein the guide portion of the convex portion is an inclined outer peripheral surface of the convex portion, and the guide portion of the concave portion is an inclined inner peripheral surface of the concave portion.

9. A case according to claim 8, wherein an angle of the outer peripheral surface of the convex portion with respect to a vertical direction of the case is substantially equal to an angle of the inner peripheral surface of the concave portion with respect to the vertical direction.

10. A case according to claim 8, wherein an inner peripheral surface of the convex portion is an inclined surface.

11. A case comprising an upper case and a lower case, the case being provided with screw bosses, disposed at predetermined positions at the upper case and the lower case, for joining the upper case and the lower case, wherein:
the screw bosses have a socket and spigot joint structure in which a convex portion of one of the screw bosses and a concave portion of the other of the screw bosses are fitted together;
an outer peripheral surface of the convex portion and an inner peripheral surface of the concave portion are inclined surfaces; and
an angle of the outer peripheral surface of the convex portion with respect to a vertical direction of the case is substantially equal to an angle of the inner peripheral surface of the concave portion with respect to the vertical direction.
